(19) United States
(12) Patent Application Publication
(10) Pub. No.: US 2013/0083377 A1
(43) Pub. Date: Apr. 4, 2013

(54) IMAGE PROCESSING APPARATUS AND IMAGE PROCESSING METHOD

(71) Applicant: Xiao DING, Saitama-ken (JP)

(72) Inventor: Xiao DING, Saitama-ken (JP)

(21) Appl. No.: 13/564,854

(22) Filed: Aug. 2, 2012

(30) Foreign Application Priority Data
Sep. 29, 2011 (JP) P2011-215735

(51) Int. Cl. H04N 1/46

(52) U.S. Cl. 358/530

(57) ABSTRACT

Provide an image processing apparatus and an image processing method which can generate an image having a high quality and a small data quantity. An image processing apparatus according to an embodiment includes a dividing unit which calculates a threshold value based on a pixel value distribution in image data, and divides pixels into two classes based on the calculated threshold value, a purification unit which prepares purified image data obtained by changing the pixel belonging to one class divided by the dividing unit into a specific color, and a pseudo-gradation binarization unit which binarizes the purified image data through a pseudo-gradation method.

### BACKGROUND OF THE INVENTION

1. Field of the Invention

Embodiments of the present invention relate to an image processing apparatus and an image processing method.

2. Description of the Related Technology

Conventionally, a technology is proposed to binarize image data input using, for example a scanner. The binarization is performed through, for example, a threshold method such as a fixing threshold method and a dynamic threshold method, and a pseudo-gradation method such as a dither method, an error diffusion method, and a density pattern method.

However, as a result of the above-described binarization process, the image quality and the data size of the image data are difficult to be compatible with each other. In other words, good image quality needs more data size,

and on the contrast less data size degrades the image quality, so that it is hard to recognize the detail data of the image with eyes.

Specifically, the image data subjected to the binarization through the threshold method has a small data quantity, but the image quality is degraded due to the occurrence of blurring or the like, so that the image data may be hardly recognized with eyes in many cases.

The image data subjected to the binarization through the pseudo-gradation method has less noise such as blurring so as to have a high quality, but a portion such as the background where no detailed expression is necessary is also expressed in gradation, so that the size of the generated image data is expanded.

FIG. 13 illustrates an example of the image data binarized through the threshold method and the image data binarized through the pseudo-gradation method in the related technology. FIG. 13 illustrates a binarization process which is performed on a basic resident register card attached with a picture thereto.

FIG. 13A illustrates the original image data before the binarization process, FIG. 13B illustrates the image data binarized through the threshold method, and FIG. 13C illustrates the image data binarized through the pseudo-gradation method. As illustrated in FIG. 13, the size of the image data obtained as a result of a threshold binarization process of FIG. 13B is smaller than that of the image data of FIG. 13C. However, a face may not be identified in the image data of FIG. 13B.

The face can be identified in the image data of FIG. 13C, but the pattern of the background is also expressed in gradation, so that the size of the image data is greater compared with that of FIG. 13B.

### SUMMARY OF THE INVENTION

The object of the invention is to provide an image processing apparatus and an image processing method which can generate an image having a high quality and a small data quantity.

An image processing apparatus according to the embodiment includes: a dividing unit which calculates a threshold value based on a pixel value distribution in image data, and divides pixels into two classes based on the calculated threshold value; a purification unit which prepares purified image data obtained by changing the pixel belonging to one class divided by the dividing unit into a specific color; and a pseudo-gradation binarization unit which binarizes the purified image data through a pseudo-gradation method.

### BRIEF DESCRIPTION OF THE DRAWINGS

FIG. 1 is a diagram illustrating an entire configuration of an image processing apparatus according to an embodiment.

FIG. 2 is a flowchart illustrating an operation of the image processing apparatus according to the embodiment.

FIG. 3 is a diagram illustrating an example of original image data which is input to the image processing apparatus according to the embodiment.

FIG. 4 is a flowchart illustrating an example of an operation of a binarization processing unit of the image processing apparatus according to the embodiment.

FIG. 5 is a flowchart illustrating an example of an operation of a threshold binarization processing unit of the image processing apparatus according to the embodiment.

FIG. 6 is a flowchart illustrating an example of an operation of a threshold binarization processing unit of the image processing apparatus according to the embodiment.

FIG. 7 is a diagram illustrating an example of pixels of image data of the image processing apparatus according to the embodiment.

FIG. 8 is a diagram illustrating an example of image data obtained as a result of a process which is performed by a threshold binarization processing unit of the image processing apparatus according to the embodiment.

FIG. 9 is a flowchart illustrating an example of an operation of a background purification processing unit of the image processing apparatus according to the embodiment.

FIG. 10 is a diagram illustrating an example of a concept of a background purification process of the image processing apparatus according to the embodiment.

FIG. 11 is a diagram illustrating an entire configuration of the image processing apparatus according to the embodiment.

FIG. 12 is a diagram illustrating an example of image data obtained as a result of a process which is performed by a pseudo-gradation binarization processing unit of the image processing apparatus according to the embodiment.

FIG. 13 is a diagram illustrating an example of image data obtained as a result of a binarization process according to the related technology.

### DETAILED DESCRIPTION OF EMBODIMENTS

Hereinafter, an image processing apparatus according to an embodiment will be described with reference to the drawings.

### First Embodiment

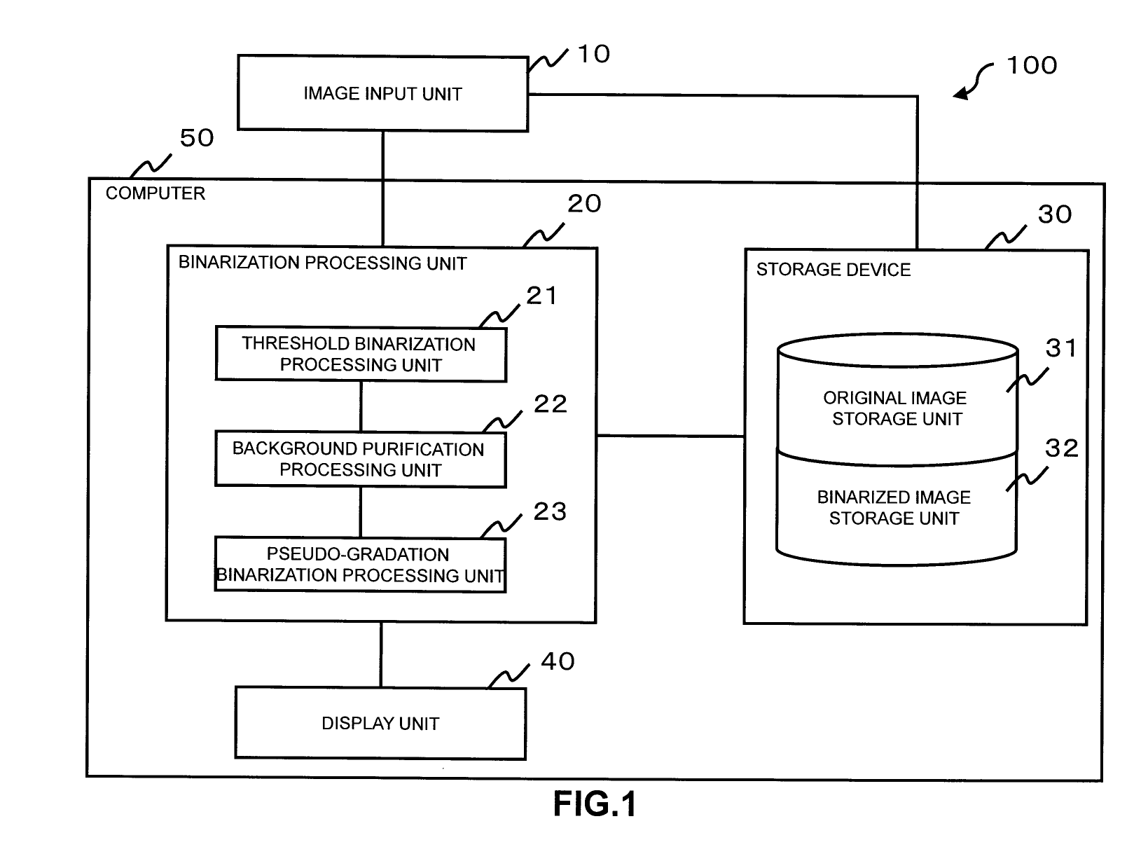

FIG. 1 is a block diagram illustrating the entire configuration of an image processing apparatus 100 according to an embodiment. As illustrated in FIG. 1, the image processing apparatus 100 is configured such that an image input unit 10 and a computer 50 such as a personal computer (PC) are connected to each other.

The image input unit 10, for example, is a scanner, which reads a surface of a form sheet or the like input therein to obtain image data and transmits the data to the computer 50. Further, the invention is not limited to the image input unit 10 for inputting the image data to the computer 50 therefrom, but another computer storing image data may be used for inputting the data.

The computer 50 includes a binarization processing unit 20, a storage device 30, and a display unit 40. The functions of the computer 50 is realized with: a memory such as a central processor unit (CPU), a random access memory (RAM), and a read only memory (ROM); an auxiliary storage device such as a hard disk device; an input device such as a keyboard; a pointing device such as a mouse; a display device such as a monitor; a hardware product such as an interface board for the image input unit 10; a program such as an operating system and image processing application software in cooperation with one another.

When the image data is input from the image input unit 10 to the computer 50, the input image data is stored in an original image storage unit 31.

The image data stored in the original image storage unit 31 is subjected to a binarization process in the binarization processing unit 20. The image data obtained as a result of the process of the binarization processing unit 20 is stored in the binarized image storage unit 32. Herein, the image data before the binarization process is performed thereon by the binarization processing unit 20 will be referred to as original image data.

The binarization processing unit 20 includes a threshold binarization processing unit 21, a background purification processing unit 22, and a pseudo-gradation binarization processing unit 23.

The threshold binarization processing unit 21 calculates a threshold value T through, for example, a discriminant analysis method based on a pixel value distribution in the original image data stored in the original image storage unit 31, and performs a threshold binarization process in which pixels are divided into two classes based on the threshold value T. The threshold binarization process will be described later.

In the image processing apparatus 100 according to the embodiment, a pixel with brightness higher than the calculated threshold value T will be assumed to belong to Class 1. In addition, an image region including pixels with brightness equal to or less than the set threshold value T will be assumed to belong to Class 2.

In the embodiment, a portion divided as Class 1 in the original image data will be referred to as a “background”, and a portion divided as Class 2 will be referred to as a “foreground”. Herein, the foreground is assumed as useful information in an image such as a picture and a character, and the background is assumed as unuseful other information. What class will be assigned to the foreground or the background is set by a user or a designer of the apparatus in advance, and the setting may be changed for every piece of the image data. In other words, the pixel with brightness higher than the calculated threshold value T may be determined as the foreground, and the pixel with brightness equal to or less than the threshold value T may be determined as the background.

The background purification processing unit 22 performs a background purification process in which the pixel determined as the foreground is kept as the pixel of the original image data without any change and the pixel determined as the background is changed into a specific color according to the processing result of the threshold binarization processing unit 21. The background purification process will be described in detail later.

The pseudo-gradation binarization processing unit 23 performs a pseudo-gradation binarization process on the image data prepared by the background purification processing unit 22, through which the gradation of the image data will be expressed using white and black pixels. The pseudo-gradation binarization process will be described in detail later.

The binarized image data generated by the pseudo-gradation binarization processing unit 23 is stored in the binarized image storage unit 32. The binarized image data stored in the binarized image storage unit 32 is output to the display unit 40. The display unit 40, for example, is a liquid crystal display. In other words, the image processing apparatus 100 includes the binarized image storage unit 32 and the display unit 40 as output units.

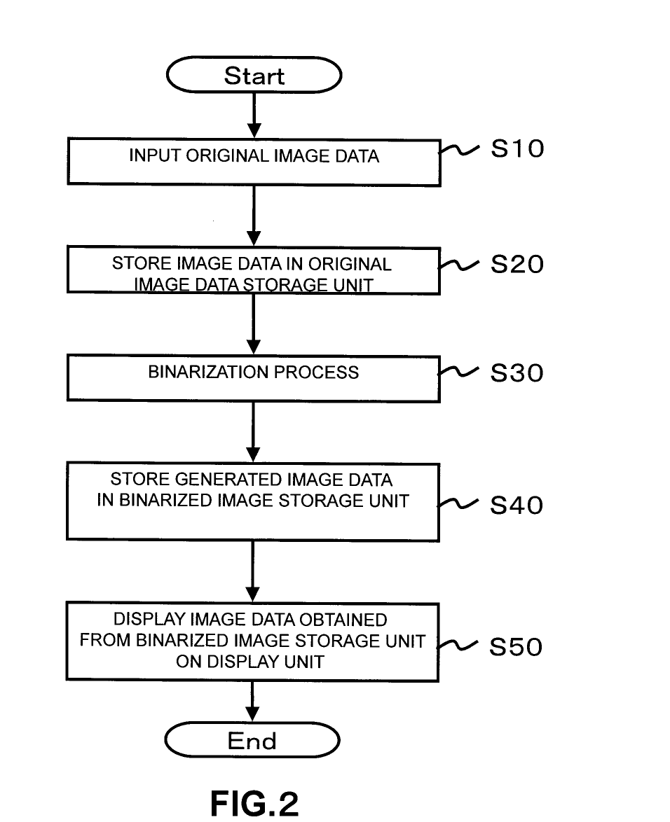

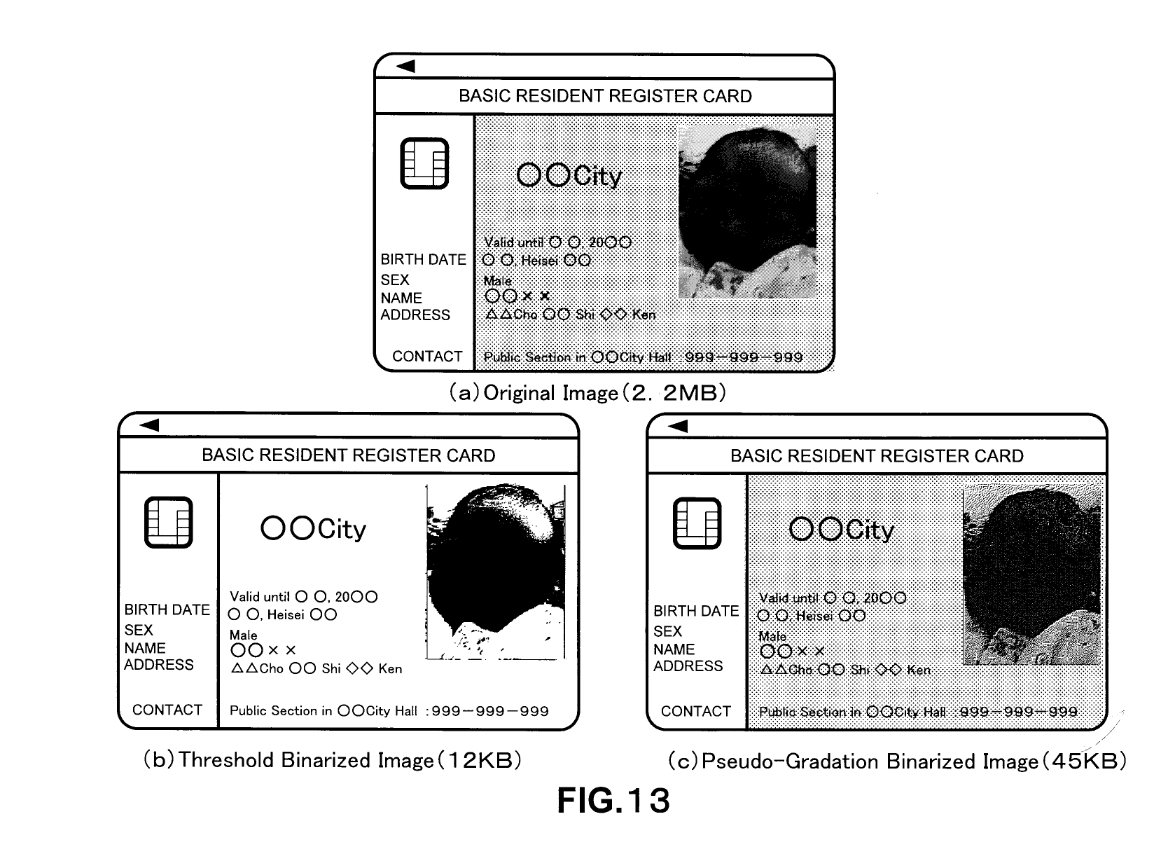

Referring to FIGS. 2 to 13, an image process performed in the image processing apparatus 100 according to the embodiment will be described.

FIG. 2 is a flowchart illustrating an example of the image process performed in the image processing apparatus 100 according to the embodiment.

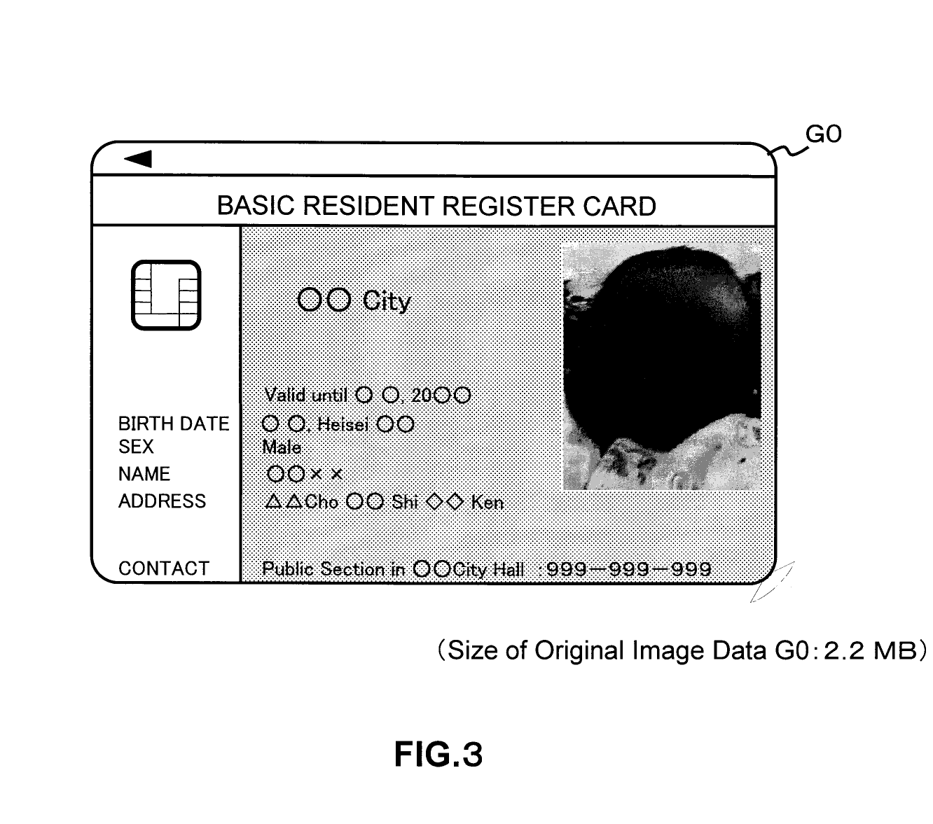

First, the image input unit 10 of the image processing apparatus 100 inputs the original image data to the computer 50 (Step S10). The computer 50 stores the input image data in the original image storage unit 31 (Step S20). FIG. 3 illustrates an example of the original image data G0 which is stored in the original image storage unit 31. As illustrated in FIG. 3, in the embodiment, a basic resident register card attached with a head shot is stored in the original image storage unit 31.

The binarization processing unit 20 obtains the original image data from the original image storage unit 31, and performs the binarization process (Step S30). Further, the binarization process may start whenever the image data is input to the computer 50, or may start in response to an instruction of the user. Alternatively, the binarization process may be performed on image data added to the original image storage unit 31 in a constant cycle.

The binarization processing unit 20 stores the binarized image data generated as a result of the binarization process in the binarized image storage unit 32 (Step S40). When the binarized image data is stored in the binarized image storage unit 32, the computer 50 displays the image data stored in the binarized image storage unit 32 on the display unit 40 (Step S50), and then ends the image process.

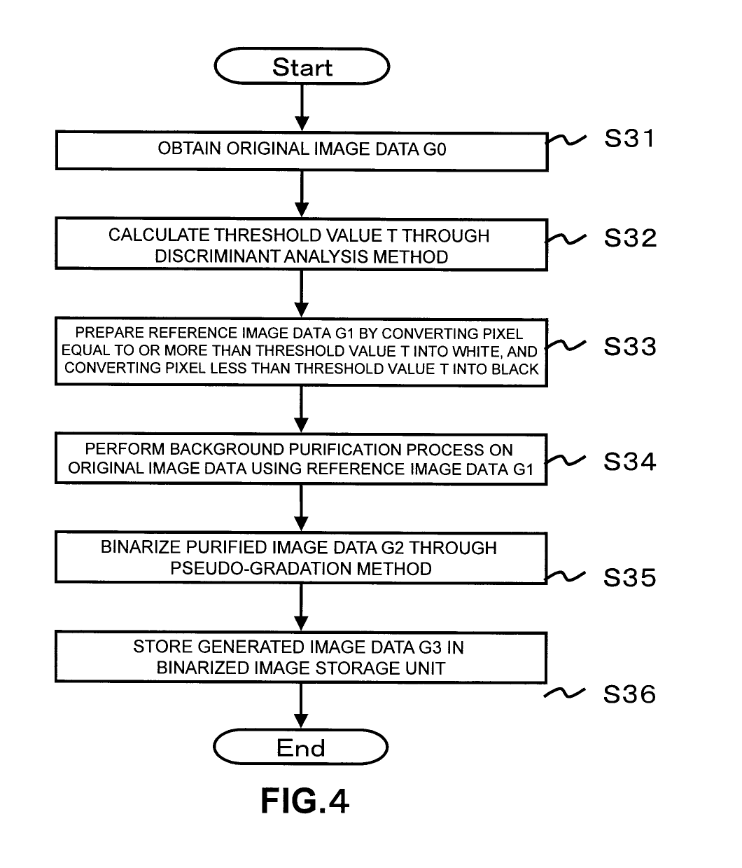

Herein, referring to FIG. 4, the binarization process performed on the image data by the binarization processing unit 20 will be specifically described. FIG. 4 is a flowchart illustrating an example of the binarization process which is performed on the image data by the binarization processing unit 20 according to the embodiment.

First, the binarization processing unit 20 obtains the original image data from the original image storage unit 31 (Step S31). FIG. 3 illustrates the obtained original image data G0.

The threshold binarization processing unit 21 performs a threshold value calculating process for calculating the threshold value T with which the original image data G0 is divided into the foreground and the background based on the pixel value distribution in the original image data G0 (Step S32). The calculation of the threshold value T, for example, is performed through the discriminant analysis method.

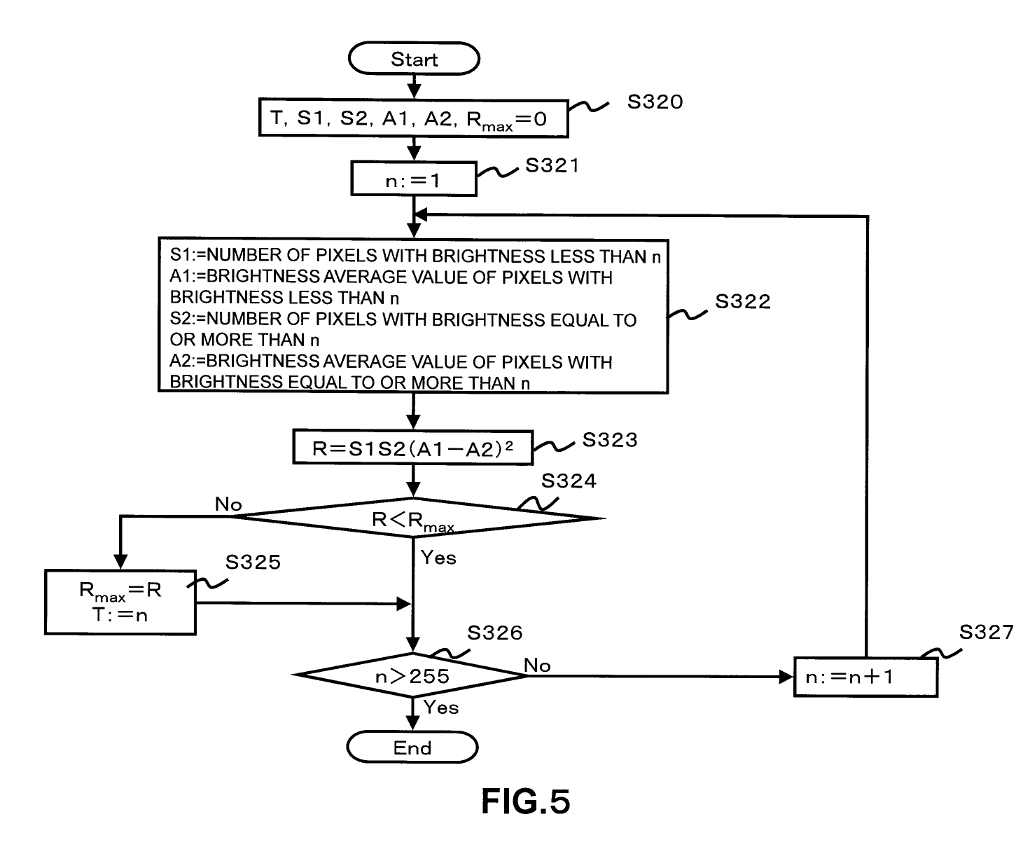

Herein, referring to FIG. 5, an example of the threshold value calculating process performed by the threshold binarization processing unit 21 in Step S32 will be specifically described. Further, the threshold value T calculated by the threshold binarization processing unit 21 corresponds to a value from 0 to 255.

Further, in the threshold value calculating process, the threshold binarization processing unit 21 calculates the threshold value T In the case a degree of dispersion a is maximized.

The degree of dispersion a is defined by the following formula.

σ=Inter-class dispersion σₓ/In-class dispersion σ_{y} (1)

In-class dispersion σₓ=(S1B1+S2B2)/(S1+S2) (2)

Inter-class dispersion σ_{y}=S1S2(A1−A2)²/(S1+S2)² (3)

The parameter 51 is the number of pixels belonging to Class 1, the parameter A1 is brightness average value of Class 1, and the parameter B1 is brightness dispersion in Class 1. Similarly, the parameter S2 is the number of pixels belonging to Class 2, the parameter A2 is brightness average value of Class 2, and the parameter B2 is brightness dispersion in Class 2.

In other words, when S1S2(A1-A2)² is maximized, the degree of dispersion σ is maximized. The threshold binarization processing unit 21 calculates the threshold value T at this time. Herein, S1S2(A1-A2)² is denoted by R, and a maximum value of R is denoted by Rₘₐₓ.

The threshold binarization processing unit 21 sets the threshold value T, the number S1 of pixels belonging to Class 1, the brightness average value A1 of Class 1, the brightness dispersion B1 in Class 1, the number S2 of pixels belonging to Class 2, the brightness average value A2 of Class 2, the brightness dispersion B2 in Class 2, and Rₘₐₓ all together to (Step S320).

In addition, herein an integer number will be denoted by “n”. The integer number n is from 0 to 255. First, the threshold binarization processing unit 21 substitutes 1 into n (Step S321).

The threshold binarization processing unit 21 substitutes the number of pixels with brightness less than n into S1, an average brightness value of pixels with brightness less than n into A1, the number of pixels with brightness equal to or higher than n into S2, and the average brightness value of pixels with brightness equal to or higher than n into A2, respectively (Step S322). The threshold binarization processing unit 21 calculates R at this time (Step S323).

In the case the calculated R is equal to or higher than Rₘₐₓ (No in Step S324), the threshold binarization processing unit 21 substitutes the calculated R into Rₘₐₓ, and n into the threshold value T (Step S325). In other words, Rₘₐₓ and the threshold value T are updated. Thereafter, it is determined whether or not n is a numerical value larger than 255 (Step S326). In the case the calculated R is less than Rₘₐₓ (Yes in Step S324), the threshold binarization processing unit 21 does not update Rₘₐₓ and the threshold value T, and determines whether or not n is a numerical value larger than 255 (Step S326).

In the case the threshold value T is a numerical value equal to or less than 255 (No in Step S326), the threshold binarization processing unit 21 substitute n+1 into n (Step S327). Thereafter, the threshold binarization processing unit 21 makes the procedure return to Step S322 and repeats the process.

In the case the threshold value T is a numerical value larger than 255 (Yes in Step S326), that is, a case where the threshold value calculating process is performed on all the pixels, the threshold binarization processing unit 21 ends the threshold value calculating process.

Herein, the description will return to FIG. 4. The threshold binarization processing unit 21 prepares reference image data obtained by comparing the calculated threshold value T with a pixel value of each pixel, converting pixels having the pixel value equal to or higher than the threshold value T among the pixel contained in the original image data into white, and converting pixels having the pixel value less than the threshold value T into black (Step S33). In other words, the threshold binarization processing unit 21 compares the calculated threshold value T with the pixel value of each pixel so as to determine that pixels having the pixel value equal to or higher than the threshold value T are the background, and to determine that pixels having the pixel value less than the threshold value T are the foreground. Then, the threshold binarization processing unit 21 prepares the reference image data obtained by converting the pixel determined as the background into white, and the pixel determined as the foreground into black.

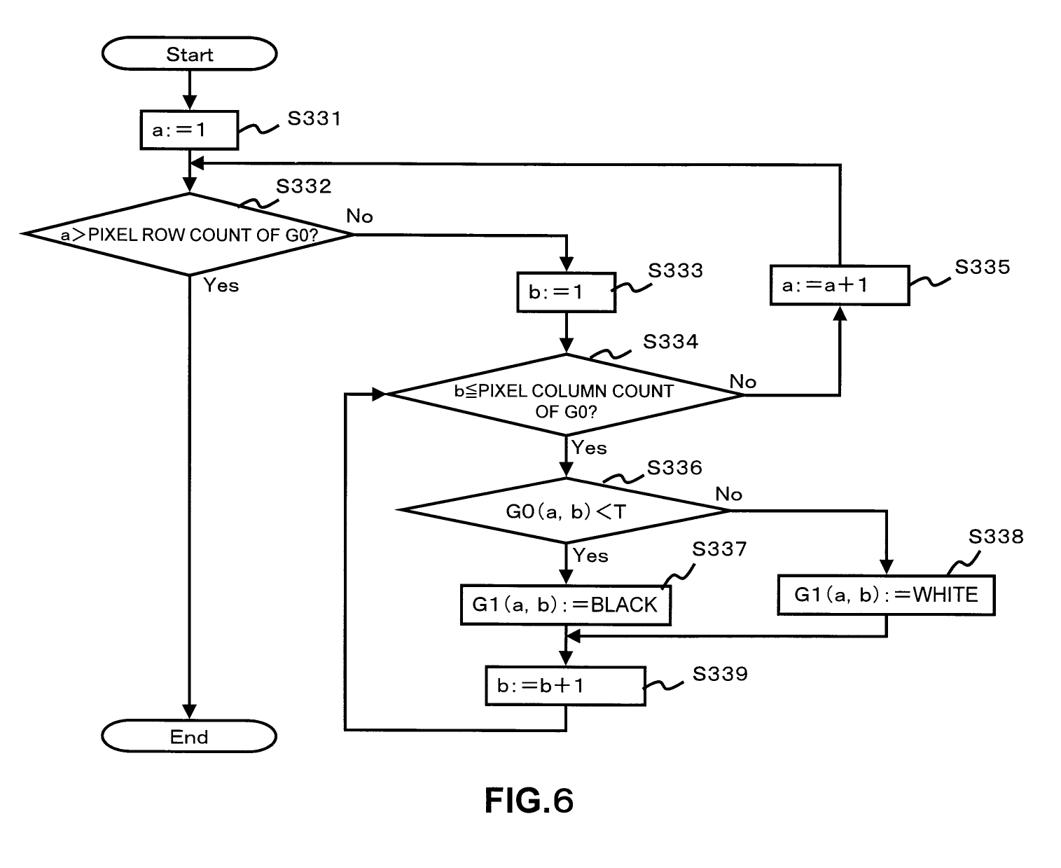

Referring to FIG. 6, a reference image preparing process performed by the threshold binarization processing unit 21 in Step S33 of FIG. 4 will be described.

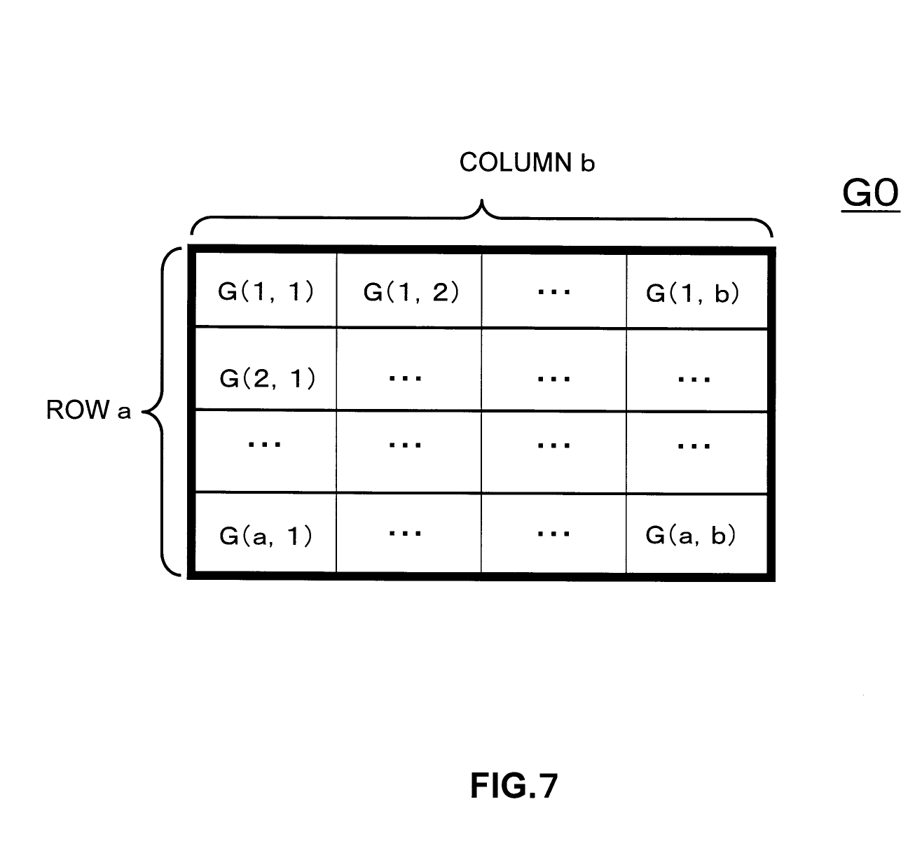

Further, the brightness of each pixel contained in a processing target of the original image data G0 will be denoted by G0 (a, b) (where, 0≦G0 (a, b)≦255). The parameter a represents the row count of the pixel, and the parameter b represents the column count of the pixel. FIG. 7 is a concept diagram illustrating the pixels of the original image data G0.

The threshold binarization processing unit 21 substitutes 1 into a (Step S331). In the case the parameter a is equal to or less than the pixel row count of the image data G0 (No in Step S332), the threshold binarization processing unit 21 substitutes 1 into b.

In the case the parameter b is equal to or less than the pixel column count of the image data G0 (Yes in Step S334), the threshold binarization processing unit 21 determines whether or not the brightness G0 (a, b) of the target pixel is equal to or higher than the calculated threshold value T (Step S336). In the case G0 (a, b) is less than the threshold value T (Yes in Step S336), the threshold binarization processing unit 21 determines that the pixel is the foreground, and converts the pixel into “black” (Step S337). In other words, if the image data after the threshold binarization process is denoted by G1, “G1 (a, b)=0 (black)” is obtained.

In the case G0 (a, b) is equal to or higher than the threshold value T (No in Step S336), the threshold binarization processing unit 21 determines that the pixel is the background, and converts the pixel into “white” (Step S338). In other words, if the image data after the threshold binarization process is denoted by G1, “G1 (a, b)=255 (white)” is obtained.

The threshold binarization processing unit 21 substitutes b+1 into b (Step S339), and repeats the process from Step S334.

In the case the parameter b is larger than the pixel column count of the image data G0 (No in Step S334), the threshold binarization processing unit 21 substitutes a+1 into a (Step S335). Thereafter, the threshold binarization processing unit 21 makes the procedure return to Step S332 and repeats the process.

In the case the parameter a is larger than the pixel row count of the image data G0 (Yes in Step S332), the threshold binarization process ends.

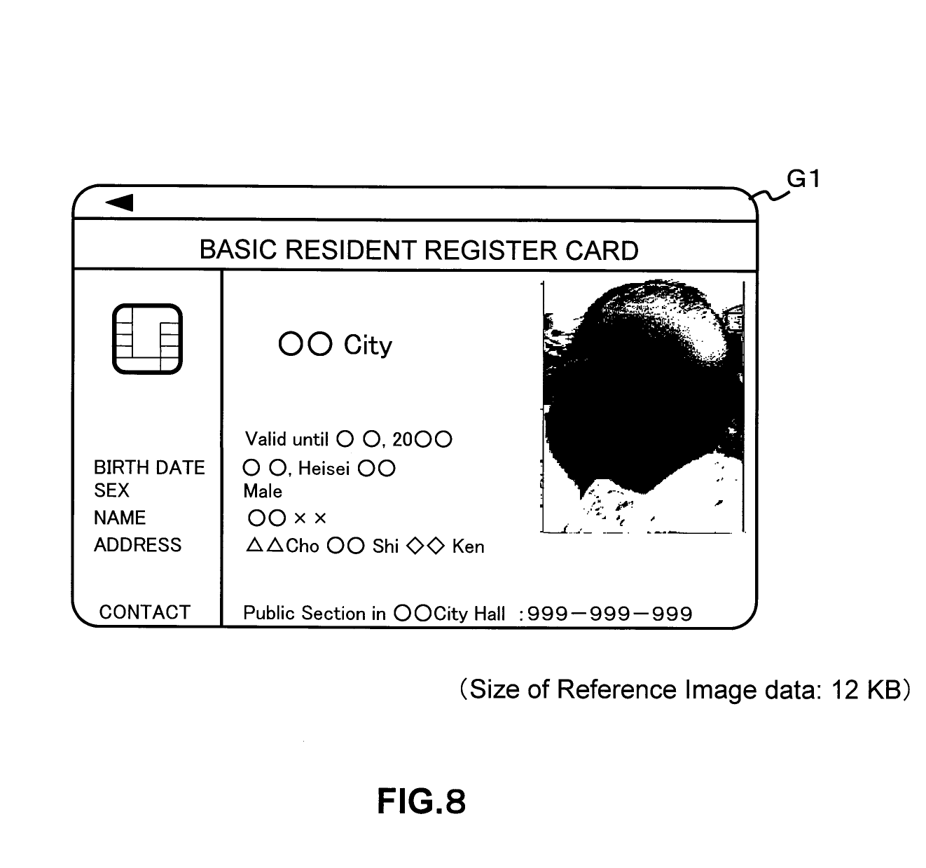

Through the above-described threshold binarization process, the threshold binarization processing unit 21 divides pixels contained in the original image data into the foreground and the background. The threshold binarization processing unit 21 converts the pixel divided into the background into white to prepare the reference image data. FIG. 8 illustrates the reference image data G1 which is prepared using the original image data G0 illustrated in FIG. 3. Further, the brightness of each pixel contained in the reference image data G1 will be denoted by G1 (a, b) (where, 0≦G1 (a, b)≦255).

The description will return to Step S34 of FIG. 4. The background purification processing unit 22 performs background purification process in which the background of the original image data G0 is changed into a specific color with reference to the original image data G0 and the reference image data G1 prepared as a result of the process of the threshold binarization processing unit 21 (Step S34). Herein, the specific color will be assumed as white.

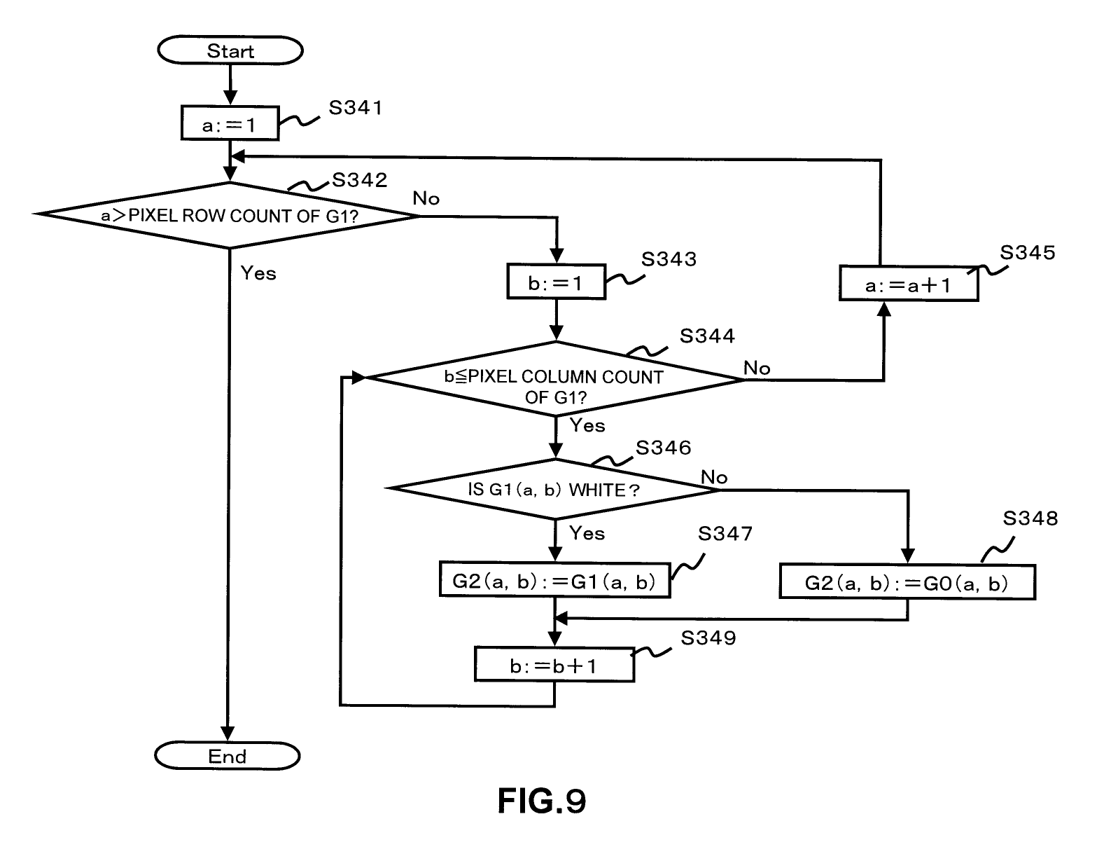

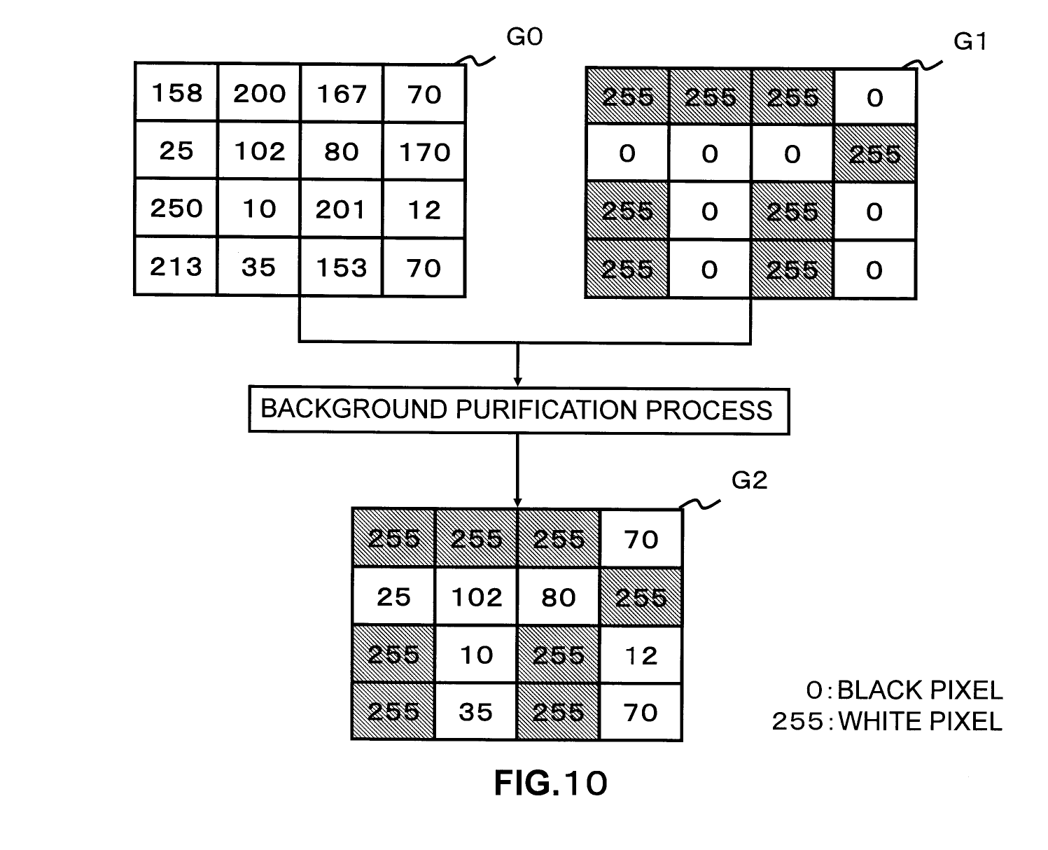

Referring to FIGS. 9 and 10, the background purification process performed by the background purification processing unit 22 will be described. FIG. 9 is a flowchart illustrating an example of the background purification process. Further, the image data obtained as a result of the background purification process will be referred to as purified image data G2.

The background purification processing unit 22 substitutes 1 into a (Step S341). In the case the parameter a is equal to or less than the pixel row count of the image data G0 (No in Step S342), the background purification processing unit 22 substitutes 1 into b.

In the case the parameter b is equal to or less than the pixel column count of the image data G0 (Yes in Step S344), the background purification processing unit 22 determines whether or not the pixel of the image data G1 is white (Step S346). In other words, it is determined whether or not G1 (a, b) is the background.

In the case G1 (a, b) is white (Yes in Step S346), the background purification processing unit 22 substitutes G1 (a, b) into G2 (a, b) (Step S347). In other words, G2 (a, b) becomes white.

In the case G1 (a, b) is not white (No in Step S346), the background purification processing unit 22 replaces the pixel into a pixel corresponding to the original image data G0 (Step S348). In other words, G1 (a, b) is substituted with G0 (a, b).

The background purification processing unit 22 substitutes b+1 into b (Step S349), and the process is repeated from Step S344.

In the case the parameter b is larger than the pixel column count of the image data G0 (No in Step S344), the background purification processing unit 22 substitutes a+1 into a (Step S345). Thereafter, the procedure returns to Step S342 and the process is repeated.

In the case the parameter a is larger than the pixel row count of the image data G0 (Yes in Step S342), the background purification process ends.

Through the above-described background purification process, the background purification processing unit 22 prepares the purified image data G2 in which the foreground portion is the original image data and the background portion is the specific color.

Further, without preparing the reference image data G1, the purified image data G2 may be prepared. In this case, the background purification processing unit 22 compares the calculated threshold value T with each pixel G0 (a, b) of the original image data G0. If the threshold value T is equal to or higher than G0 (a, b), the background purification processing unit 22 converts the pixel into white. In other words, the background purification processing unit 22 sets G2 (a, b)=255 in the purified image data G2.

If the threshold value T is less than G0 (a, b), the background purification processing unit 22 does not convert the pixel but keeps the original image data without any change. In other words, the background purification processing unit 22 sets G2 (a, b)=G0 (a, b) in the purified image data G2.

FIG. 10 illustrates a concept diagram of the background purification process. As illustrated in FIG. 10, the purified image data G2 is prepared by the background purification processing unit 22 such that the pixel (the shaded area) of the background in the reference image data G1 is reflected without any change, and the pixel of the foreground in the reference image data G1 is reflected with the pixel of the corresponding original image data.

The description will return to FIG. 4. The pseudo-gradation binarization processing unit 23 performs the pseudo-gradation binarization process in which the purified image data G2 obtained as a result of the process of the background purification processing unit 22 is expressed using a black-and-white gradation (Step S35). The pseudo-gradation binarization process, for example, is performed through a pseudo-gradation method. Examples of the pseudo-gradation method include a dither method, an error diffusion method, a density pattern method, and the like, and in the embodiment the error diffusion method is employed.

Here, the error diffusion method is a type of the pseudo-gradation method of expressing the gradation, in which the conversion is performed by dynamically changing a ratio of black pixels according to brightness. In other words, the error diffusion method is a method in which an error generated in a previous pixel is added to the next pixel.

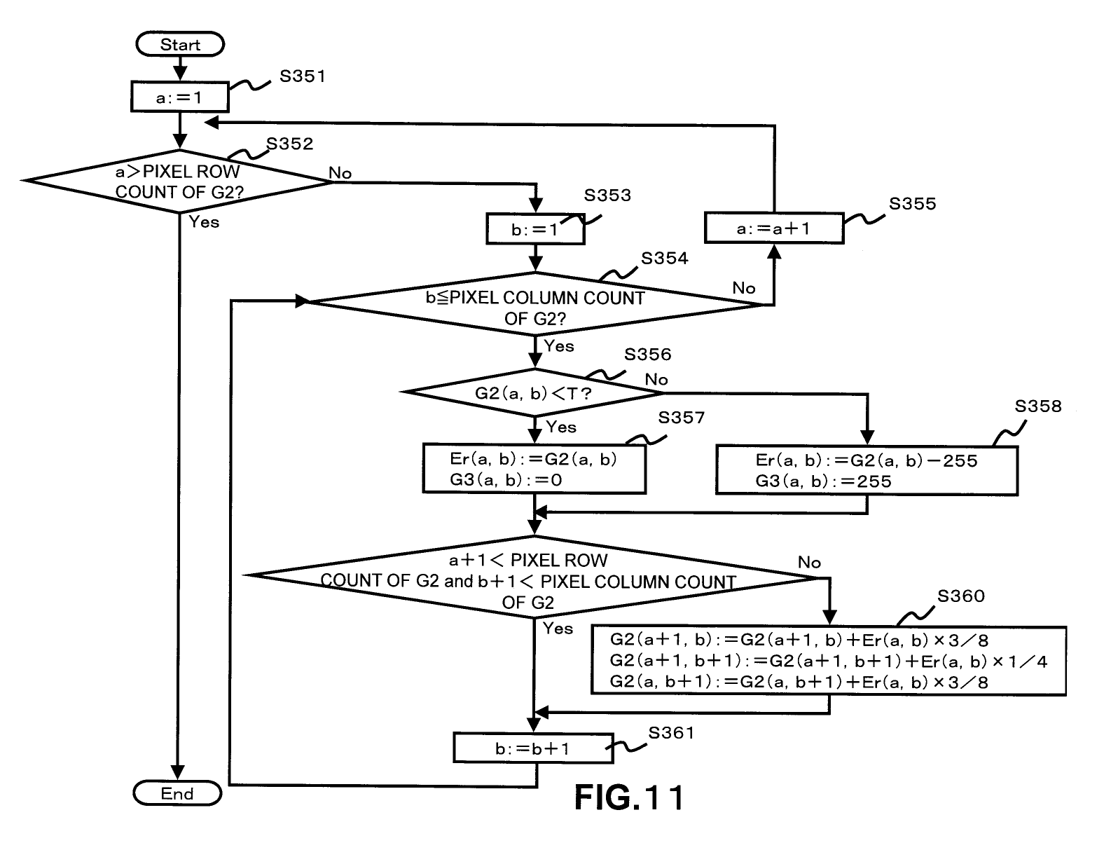

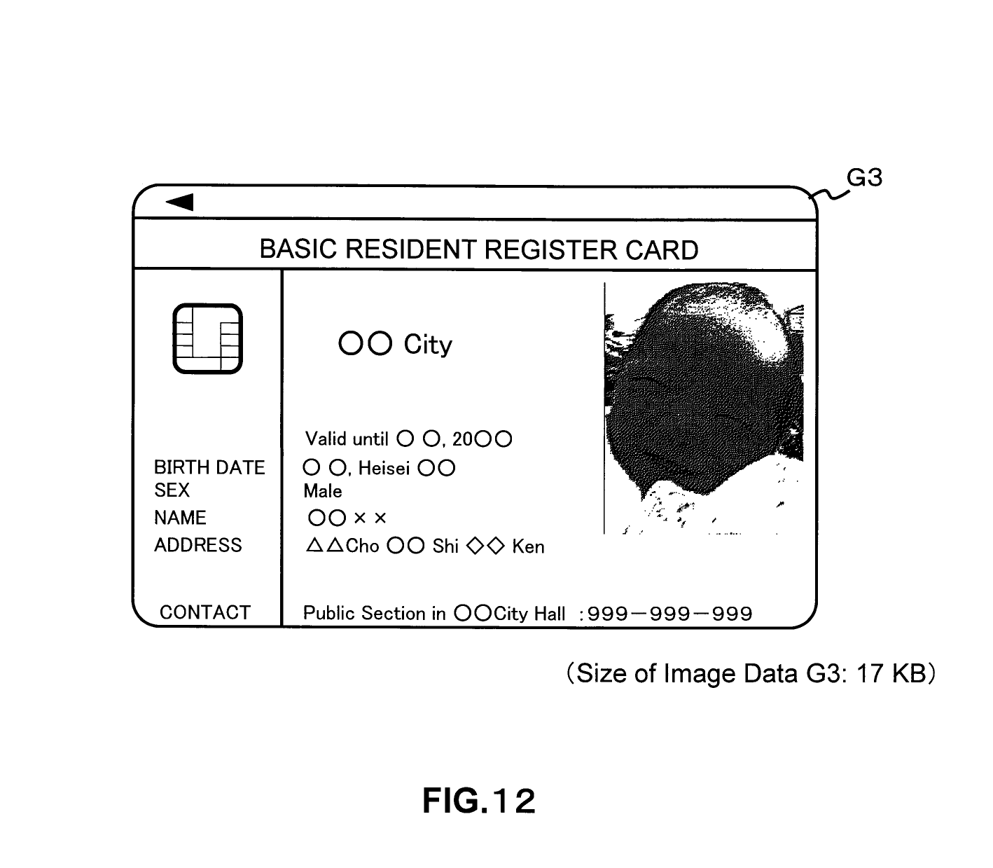

Referring to FIGS. 11 and 12, the process of the pseudo-gradation binarization processing unit 23 will be described.

FIG. 11 is a flowchart illustrating an example of the operation of the pseudo-gradation binarization processing unit 23. In addition, the image data prepared by the pseudo-gradation binarization processing unit 23 will be denoted by G3, the brightness of each pixel contained in the image data G3 will be denoted by G3 (a, b). In addition, when a pixel is binarized based on the threshold value T, a difference between the pixel values before and after the binarization will be denoted by an error Er(a, b).

First, the pseudo-gradation binarization processing unit 23 substitutes 1 into a (Step S351). In the case the parameter a is equal to or less than the pixel row count of the image data G2 (No in Step S352), the pseudo-gradation binarization processing unit 23 substitutes 1 into b.

In the case the parameter b is equal to or less than the pixel column count of the image data G2 (Yes in Step S354), the pseudo-gradation binarization processing unit 23 determines whether or not the brightness of the pixel of the image data G2 is less than the threshold value T calculated by the threshold binarization processing unit 21 (Step S356). In other words, it is determined whether or not G2 (a, b)<T is satisfied.

In the case of G2 (a, b)<T (Yes in Step S356), the pseudo-gradation binarization processing unit 23 substitutes G2 (a, b) into the error Er(a, b) and substitutes 0 into G3(a, b) (Step S357).

In the case of G2 (a, b)≧T (No in Step S356), the pseudo-gradation binarization processing unit 23 substitutes G2 (a, b)-255 into the error Er(a, b) and substitutes 255 into G3(a, b) (Step S358).

In other words, in the image data G2 obtained as a result of the process of the background purification processing unit 22, the error Er(a, b) of the white pixel becomes 0. In the image data G2 obtained as a result of the process of the background purification processing unit 22, the error Er (a, b) of other than the white pixel becomes the brightness of the pixel.

Herein, In the case a+1 is equal to or higher than the pixel row count of G2 or b+1 is equal to or higher than the pixel column count of G2 (No in Step 359), the pseudo-gradation binarization processing unit 23 substitutes G2 (a+1, b)+Er (a, b)×⅜ into G2 (a+1, b), G2 (a+1, b+1)+Er(a, b)×¼ into G2 (a+1, b+1), and G2 (a, b+1)+Er(a, b)×⅜ into G2 (a, b+1) (Step S360).

Following Step S360, alternatively, In the case a+1 is less than the pixel row count of G2 and b+1 is less than the pixel column count of G2 (Yes in Step S359), the pseudo-gradation binarization processing unit 23 substitutes b+1 into b, and repeats the process from Step S354.

In the case the parameter b is larger than the pixel column count of the image data G2 (No in Step S354), the pseudo-gradation binarization processing unit 23 substitutes a+1 into a (Step S355). Thereafter, the procedure returns to Step S352 and the process is repeated.

In the case the parameter a is larger than the pixel row count of the image data G2 (Yes in Step S352), the pseudo-gradation binarization process ends.

In this way, the pseudo-gradation binarization process can be performed only on the pixel of the foreground divided into Class 2 using the background purification processing unit 22.

The description will return to Step S36 of FIG. 4. The binarization processing unit 20 stores the image data G3 prepared by the pseudo-gradation binarization processing unit 23 into the binarized image storage unit 32 (Step S36). Then, the process performed by the binarization processing unit 20 ends. FIG. 12 illustrates an example of the image data G3.

As described above, the image processing apparatus 100 according to the embodiment converts the pixel, which is determined to be less than the threshold value T, to one specific color through the threshold binarization process. By performing the pseudo-gradation binarization process on the image data of which the background is set to one specific color through the threshold binarization process, a useful portion in a picture and the like can be identified, and the image data having a small data quantity can be generated. In other words, the image processing apparatus 100 can generate a binarized image having a high quality and a small data quantity.

Hereinbefore, although the embodiment of the invention has been described, the embodiment is suggested as a mere example and is not intended to limit the scope of the invention. The novel embodiment can be implemented in various other forms, and various omissions, replacements, and changes can be made without departing from the concept of the invention. The embodiments and modifications are included in the scope and the concept of the invention, and also included in the scope of the invention set forth in claims and the equivalents thereof.

1. An image processing apparatus comprising:
a dividing unit which calculates a threshold value based on a pixel value distribution in image data, and divides pixels into two classes based on the calculated threshold value;
a purification unit which prepares purified image data obtained by changing the pixel belonging to one class divided by the dividing unit into a specific color; and
a pseudo-gradation binarization unit which binarizes the purified image data through a pseudo-gradation method.

2. An image processing apparatus comprising:
an input unit which inputs image data;
a storage unit which stores the input image data;
a threshold binarization processing unit which calculates a threshold value based on a pixel value distribution in the image data, and prepares reference image data obtained by binarizing the image data based on the calculated threshold value;
a purification unit which prepares purified image data obtained by replacing a pixel having a pixel value among the pixels contained in the reference image data into a pixel corresponding to original image data; and
a pseudo-gradation binarization unit which binarizes the purified image data through a pseudo-gradation method.

3. An image processing apparatus comprising:
an input unit which inputs image data;
a storage unit which stores the input image data;
a calculating unit which calculates a threshold value based on a pixel value distribution in the image data;
a purification unit which prepares purified image data obtained by changing a pixel of which a pixel value is equal to or higher than the calculated threshold value among the pixels contained in the image data into a specific color; and
a pseudo-gradation binarization unit which binarizes the purified image data through a pseudo-gradation method.

4. An image processing apparatus comprising:
an input unit which inputs image data;
a storage unit which stores the input image data;
a calculating unit which calculates a threshold value based on a pixel value distribution in the image data;
a purification unit which changes a pixel of which a pixel value is equal to or less than the calculated threshold value into a specific color; and
a pseudo-gradation binarization unit which binarizes the purified image data through a pseudo-gradation method.

5. The image processing apparatus according to claim 3, wherein the specific color is white or black.

6. The image processing apparatus according to claim 4, wherein the specific color is white or black.

7. The image processing apparatus according to claims 1, further comprising
an output unit which outputs image data obtained as a result of a process performed by the pseudo-gradation binarization unit.

8. The image processing apparatus according to claims 2, further comprising
an output unit which outputs image data obtained as a result of a process performed by the pseudo-gradation binarization unit.

9. The image processing apparatus according to claims 3, further comprising
an output unit which outputs image data obtained as a result of a process performed by the pseudo-gradation binarization unit.

10. The image processing apparatus according to claims 4, further comprising
an output unit which outputs image data obtained as a result of a process performed by the pseudo-gradation binarization unit.

11. The image processing apparatus according to claims 5, further comprising
an output unit which outputs image data obtained as a result of a process performed by the pseudo-gradation binarization unit.

12. The image processing apparatus according to claims 6, further comprising
an output unit which outputs image data obtained as a result of a process performed by the pseudo-gradation binarization unit.

13. An image processing method of an image processing apparatus which comprises a storage unit configured to store image data, the method comprising:
inputting image data;
storing the input image data;
calculating a threshold value based on a pixel value distribution in the image data, and dividing pixels into two classes based on the calculated threshold value;
preparing purified image data which is obtained by changing a pixel belonging to one class divided from the image data into a specific color; and
binarizing the purified image data through a pseudo-gradation method.
